(19) United States
(12) Patent Application Publication
(10) Pub. No.: US 2011/0124409 A1
(43) Pub. Date: May 26, 2011

(54) GRAPHICAL OBJECT CUSTOMIZATION BASED ON PERFORMANCE METRICS

(76) Inventors: Nick Baynes, Brighton (GB); Serkan Hassan, Brighton (GB)

(21) Appl. No.: 12/626,339

(22) Filed: Nov. 25, 2009

(51) Int. Cl. A63F 13/00; A63F 9/24

(52) U.S. Cl. 463/30; 463/42; 463/43

(57) ABSTRACT

System, method and article for modifying graphical objects in a gaming environment based on performance metrics. The appearance and/or performance of a vehicle, avatar or other graphical object automatically changes depending on player performance, without the need for a user to make a manual selection.

### BACKGROUND

1. Field

The invention is concerned with interactive computer games, and in particular with interactive computer games where multiple users may play an interactive computer game together. The invention is applicable to interactive computer games in which multiple users are connected via a network such as the Internet, as well as stand-alone interactive computer games.

2. Description of the Related Art

The general architecture to support an interactive computer gaming session between multiple users in a network environment is illustrated in FIG. 1. Such an architecture, and variations thereto, is well-known to one skilled in the art.

As used herein the term computer gaming session encompasses any length of time spent playing a game. A computer gaming session may, for example, be a completed game, a completed level of a game, a completed race of a racing game, a completed lap of a race in a racing game or any other section of a game. A gaming session may be measured in units of time or in discrete game sections.

FIG. 1 illustrates three computer game systems, or terminals, 2a, 2b, 2c. Each system is connected to a network 6 via a respective network connection 4a, 4b, 4c. The network 6 may be the Internet. A server 8 is also connected to the network 6 via a network connection 10. As illustrated with reference to computer game system 2a, each computer game system typically includes a computer game console 12 or hardware device, a player/user input device or controller 18 connected to the computer game hardware device 12, and a display 20 connected to the computer game hardware device. The computer game console 12 is adapted for connection to the network connection 4a. Although in the example shown the controller 18 and display 20 are shown as distinct from the console 12, the computer game system may be implemented in a variety of ways, for example with the controller, display and console forming a single integrated device.

The server 8 allows for details of interactive games to be uploaded thereto, so as they may be displayed to other users. A games player, such as a games player associated with computer game system 2a, may initiate a new interactive game, and upload details to the server 8.

The initiation of the game creates a so-called lobby for the game. On a player registering to play a game, in accordance with various known techniques, a suitable screen is displayed to the player. The screen may display, for example, the identity of all players of the game, showing game details and options, and a list of game players.

On registering to play a game, whether in an online environment or in a stand-alone game system, a player must select a player vehicle which will represent his involvement in the game. Vehicles can often be customized to a player's requirements by a user selecting modifications to a vehicle. The selected modifications affect how an image of the vehicle is rendered during game play.

In order to customize a vehicle according to the known process, a user is generally presented with an image of the basic vehicle and multiple images of possible modifications to the vehicle. In order to select a modification, a user can click on the displayed modification image or use a menu system. The modifications can include altered livery or paint schemes, changed body kit parts etc. The existing vehicle modification processes operate using a series of complex menus, sliders and options. It is an aim of the present invention to deliver a vehicle customization functionality which is simpler and thus more readily available to a wider class of game players.

### SUMMARY

Embodiments of the invention provide automatic changes of the appearance and/or performance of a vehicle, avatar, or other graphical object in response to player performance, without the need for a user to make a manual selection.

According to an aspect of the invention there is provided a method of operating an interactive computer game on a computer games terminal comprising: receiving interactive game data from a user for playing a game, said game data controlling animation of an image of a graphical object rendered on a display of a computer games terminal; deriving at least one performance metric based on the interactive game data; selecting at least one modification from a set of predetermined modifications associated with the at least one performance metric; and automatically applying the at least one modification to the graphical object, without requiring input data from the user to select said modifications.

The graphical object may be a vehicle, avatar or any other object.

As used herein the term “performance metric” encompasses any measurable aspect of the performance of a player during a gaming session. Performance metrics may relate to a player's progress through a game, successes within a game and/or style of playing a game. Performance metrics are explained in greater detail below.

Said at least one modification may affect the appearance of the image and may be selected from the group comprising: color; liveries; materials; lights; decals; race number; and physical shape.

Said at least one performance metric may be related to the position of a participant vehicle in a multi-user game, the race number being selected based on said position.

Said at least one modification may affect the performance characteristics and capabilities of the animation of the image in the game responsive to game data received from the user, such that the vehicle is perceived by the user to have a performance altered by the modifications.

Said at least one modification may be selected from the group comprising: improvements in control; and the addition of new abilities.

Said at least one performance metric may be based on a player's progress through the interactive game and may be selected from the group comprising: completing a predetermined number of races; completing a predetermined set of races; scoring a predetermined number of points within a gaming session; achieving a predetermined ranking on a leaderboard; and attaining a predetermined time on a race course.

Said at least one performance metric may be derived based on a player's style (skill) of game play and may be selected from the group comprising: drifting around the corners of a course; jumping; and slipstreaming a rival player.

The method may comprise the step of storing said set of predetermined modifications in a first storage means; and maintaining a user profile in a second storage means, wherein said step of applying may include adding said selected at least one modification to the user profile at said second storage means.

The interactive computer game may be operated in a network comprising a server and a plurality of computer game terminals and wherein the first storage means may be located at a server and the second storage means may be located at the computer games terminal.

According to another aspect of the invention there is provided a system for operating an interactive game on a computer games terminal comprising: means for receiving interactive game data from a user for playing a game, said game data controlling animation of an image of a graphical object rendered on a display of the computer games terminal; means for deriving at least one performance metric based on the interactive game data; means for selecting at least one modification from a set of predetermined modifications associated with the at least one performance metric; and means for applying the at least one modification to the graphical object without receiving data from the user to select said at least one modification.

The system may further comprise a first storage means for storing the set of predetermined modifications and a second storage means for maintaining a user profile, wherein the means for applying the at least one modification to the vehicle image may be adapted to add the selected at least one modification to the user profile at the second storage means.

The computer game may be operated in a network comprising a server and a plurality of computer game terminals and wherein the first storage means may be located at a server and the second storage means may be located at the computer games terminal.

The computer game may be operated on a computer games terminal, and wherein the first and second storage means may be located at the computer games terminal.

According to another aspect of the invention there is provided a game server for managing an interactive computer gaming session connected in a network to a plurality of computer game terminals comprising: a network interface adapted to receive over the network from a computer games terminal one or more performance metrics based on interactive game data received from a user at the computer games terminal; a modification selecting component arranged to select at least one modification from a set of predetermined modifications stored in a memory, based on the one or more performance metrics without requiring user input data, wherein the network interface is also adapted to transmit the selected at least one modification over the network to the computer games terminal.

According to another aspect of the invention there is provided a computer games terminal for operating an interactive computer game comprising: a processor; and a memory storing program code which when executed causes the processor to render an image of a graphical object on a display of the computer games terminal to receive interactive game data based on user inputs, the game data controlling animation of the image in the game, to determine at least one performance metric based on the interactive game data; and to apply at least one modification, selected from a set of predetermined modifications, to the graphical object without requiring input data from the user to select said at least one modification.

According to another aspect of the invention there is provided a computer program embodied on a computer readable medium for operating an interactive computer game on a computer games terminal, the computer program comprising code which when executed carries out the steps of: rendering an image of a graphical object on a display of the computer games terminal; receiving interactive game data from a user for playing a game, said interactive game data controlling animation of the image in the game; deriving at least one performance metric based on the interactive game data; and applying at least one modification, selected from a predetermined set of modifications, to the graphical object, without requiring input data from the user to select said modifications.

According to another aspect of the invention there is provided a computer program embodied on a computer readable medium for operating a server in a network comprising a plurality of computer games terminals connected to each other and to the server, the computer program comprising code which when executed carries out the steps of: receiving over the network from a computer games terminal one or more performance metrics based on interactive game data received from a user at the computer games terminal; selecting at least one modification from a set of predetermined modifications stored in a memory based on the one or more performance metrics without requiring user input data; and transmitting the selected at least one modification over the network to the computer games terminal.

The invention will now be described by way of example with reference to the accompanying figures.

### BRIEF DESCRIPTION OF THE FIGURES

FIG. 1 is a schematic diagram showing the general architecture to support an interactive computer gaming session between multiple users in a network environment;

FIG. 2A is a schematic diagram of an exemplary computer games terminal;

FIG. 2B is a schematic diagram of an exemplary game server;

FIG. 3 is a schematic diagram of a user profile;

FIG. 4 is a schematic diagram of a modifications table;

FIG. 5 is a flow diagram showing the main process steps for operating an interactive computer game;

FIG. 6A shows an exemplary modification to a rendered vehicle image;

FIG. 6B shows an exemplary modification to a rendered vehicle image; and

FIG. 6C shows an exemplary modification to a rendered vehicle image;

### DESCRIPTION

In one embodiment, the appearance and/or performance of a vehicle, avatar or other graphical object automatically changes depending on player performance, without the need for a user to make a manual selection.

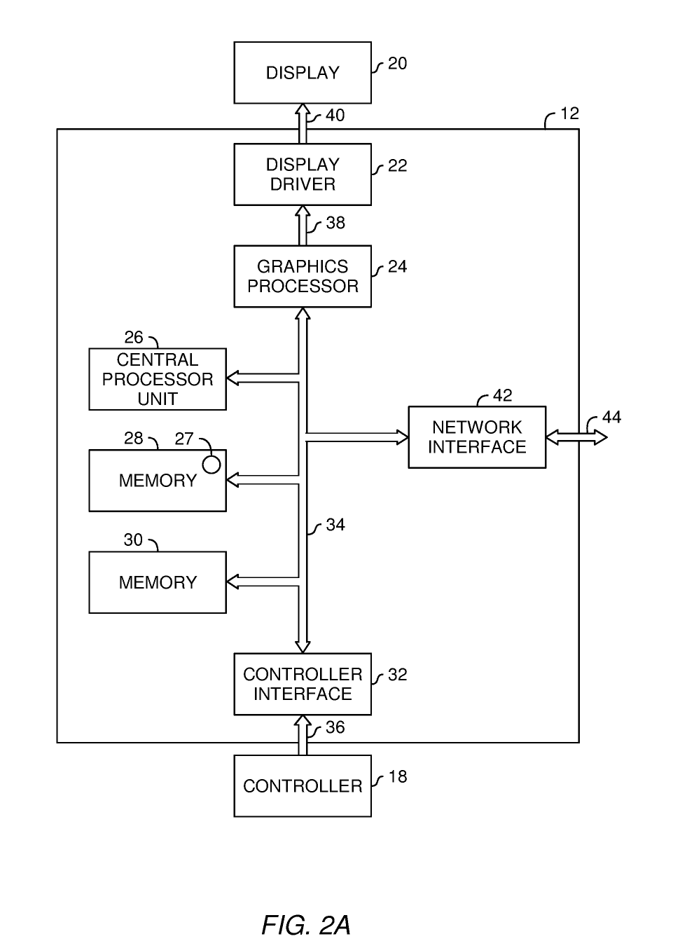

An example interactive game device or system is shown in FIG. 2A, and denoted by reference numeral 12. The device includes a graphics processor 24 controlling a display driver 22 via a graphics bus 38, a controller interface 32 receiving controller data on a controller interface bus 36, a central processor unit (CPU) 26, a network interface 42 connected to a network bus 44, and memory modules 28 and 30. A system bus 34 connects various elements. The display driver 22 drives the display 20 via display bus 40.

The example interactive game device of the invention may include one or more monitors on which graphics may be displayed such as one or more LCDs (Liquid Crystal Display) and such a display or monitor may be provided within the game housing or as a separate monitor (such as a television). While LCDs are one preferred embodiment, the monitor or display device may be of any other suitable type, e.g., an EL (Electro Luminescence) display device. Moreover, the resolution of the monitor or display device is not limited to the particular resolution used herein. One or more speakers allowing game sounds to pass through may also be provided as part of the interactive game device or external speakers may be used such as provided in a television or attached to the game device. The interactive game device may include user input or interface devices such as a set of input devices that may include typical video game input devices such as a cross-shaped switch, a start switch, a select switch, an A button, a B button, an X button, a Y button, a power switch, a left or L button, a right or R button, and the like such as a touch screen or peripherals such as a joystick. Another input device is a touch panel or screen attached on the screen of a second LCD. The housing in many embodiments includes slots for accommodating a memory card (e.g., a game cartridge). The memory card or game cartridge is a storage medium storing the interactive game program run by the interactive game device and, typically, for storing the animations described herein. In other embodiments, though, the interactive game program(s) and graphics may be accessed via a communications network such as the Internet (as described herein).

In implementations in which the video game device is a portable device or is a device that is linked to a television or other monitor/speaker system, the internal configuration of the video game device may include a CPU 26 mounted on an electronic circuit board positioned in the game housing. The CPU 26 may be connected to an input/output interface circuit, one or more GPU (Graphics Processing Unit) 24 and a monitor controller as display driver 22 such as via bus 34. A connector or memory interface may be provided for receiving a memory card, which may include ROM storing the video game program including the animations and RAM such as for rewritably storing backup data. The video game program stored in the ROM of the memory card is typically loaded to the RAM, and the loaded video game program is executed by the CPU during operation of the video game device. In addition to the video game program, the RAM also stores temporary data produced while the CPU is running a program. The input/output circuit may be connected to the user inputs or control switch section (e.g., user interface) and monitor. Video RAM or VRAM may be used to provide storage of animations or images rendered according to the invention and may be stored in RAM prior to display by the GPU or other graphics controllers. Memory blocks 28 and 30 connected to bus 34 represent different possible types of memory.

As will be clear to those skilled in the art, numerous embodiments of interactive game apparatus and interactive game controllers may be used to practice the present invention, e.g., to run the methods described herein as part of an interactive video game program stored on a storage medium such as memory card, game cartridge, or the like, and the above description of an interactive game device is not intended to limit the breadth of coverage. For example, the interactive game program may be stored on a disk (e.g., a CD or other data storage media) and downloaded into a computer's memory to be run or run from disk. Alternatively, the game program and its animations may be accessed by using an electronic device to access a Web site or to access (in a wired or wireless manner) memory over a digital communications network such as the Internet and the interactive game may be run remotely or after storage on local memory.

It is specifically contemplated that embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Cloud computing resources may be provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a game program) or related data available in the cloud. For example, the racing game described herein could execute on a computing system in the cloud and monitor the user while interacting with the game. In such a case, the racing game could determine performance metrics and apply appropriate vehicle modifications as appropriate and store an indication of such modifications at a storage location in the cloud. Doing so allows a user to access this information, i.e., the performance modifications, from any computing system attached to a network connected to the cloud (e.g., the Internet). In this way, a user who desires to subsequently play the racing game by executing an instance of the game hosted on a home gaming console, may retrieve the vehicle modifications from the storage location in the cloud.

Embodiments of the invention are based around the principle that the software of a computer game may monitor one or more aspects of a player's performance within a game play environment and modify the physical appearance and performance characteristics of the player's vehicle to reflect their unique experience.

A player's ability, success rate, personal preferences and a host of other data may be considered by the software in order to automatically modify the player's vehicle.

The following descriptions of embodiments of the invention described with reference to a car racing game. However, it will be apparent to those skilled in the art that the invention is not limited to implementation in a racing game but may be implemented in games of any format.

Computer game terminals of the art are adapted to run software for playing interactive computer games. As used herein, the term “car racing game” relates to such software that may be run on the central processor 26 of a games console 12. A racing game may provide a game in which a plurality of game characters compete to win a race around a course. The game characters may be player controlled and/or computer controlled.

Referring to FIG. 2B there is shown a schematic representation of an exemplary game server 8. The game server 8 includes a network interface 80 connected to a network 6. The network 6 may be the Internet. The network interface 80 is connected to a modification selection means 82 and to a memory 84. The modification selection means is also connected to the memory 84.

The network interface is configured to receive data over the network 6. The data may include data from computer game terminals 2a, 2b, 2c. According to the invention the modification selection means 82 is configured to select at least one modification from a set of predetermined modifications. The set of predetermined modifications may be stored in the memory 84. The network interface 80 may be additionally configured to transmit the selected modification over the network 6 to a computer games terminal 2a, 2b, 2c.

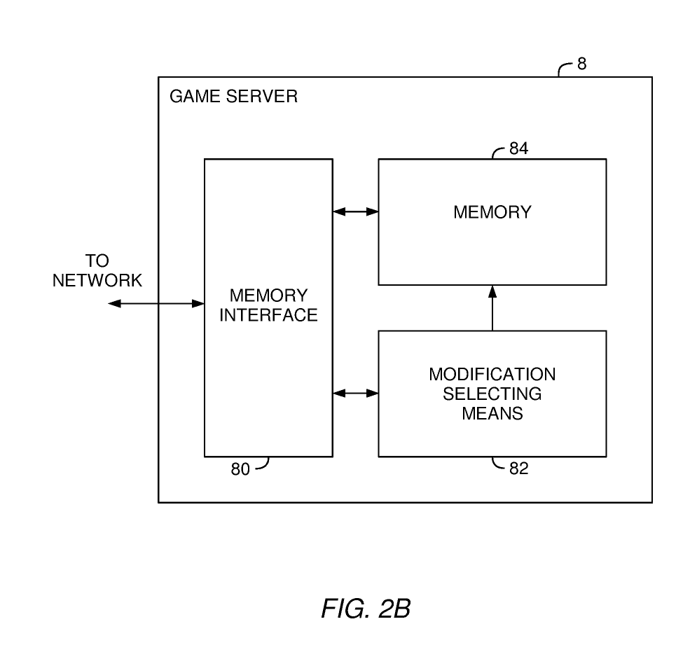

FIG. 3 illustrates schematically a user profile 50 which is held in the memory units 28, 30 of a game system 2a, 2b, 2c. Each player has a user profile 50 associated with them which includes a user identifier 50a which allows the user to register for a game, and other data associated with the user. For the purposes of exemplifying the invention, the only other data which is described in detail is that associated with a player vehicle at field 50b. The user profile has additional fields 50c, 50d for holding modifications to a basic vehicle 50b for the purpose of customizing the vehicle. Such modifications are described and illustrated in more detail in the following.

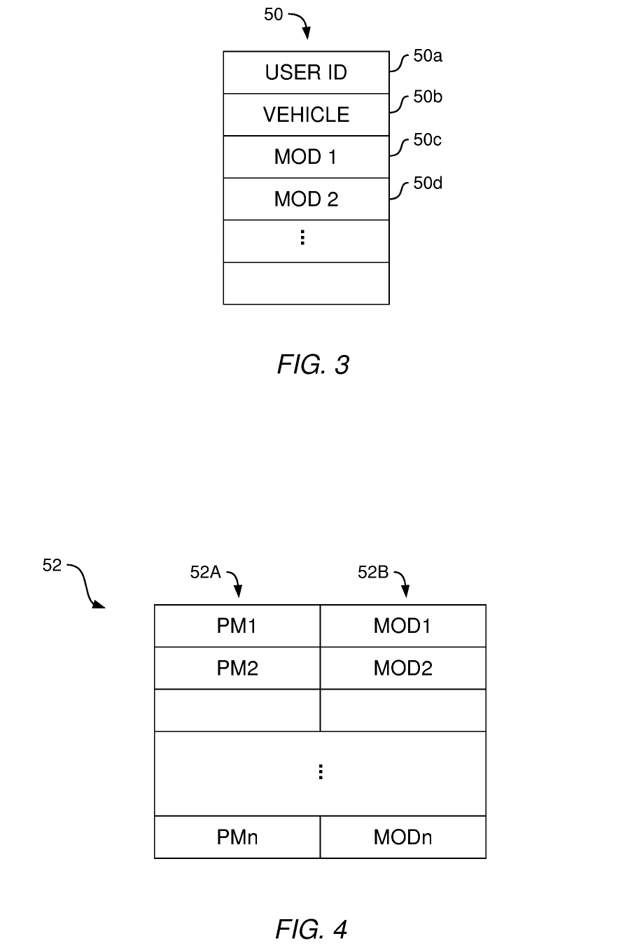

FIG. 4 is a schematic diagram of a modifications table 52. The modifications table 52 is independent of the players' user profiles and holds a plurality of modifications MOD1, MOD2 . . . MODn (column 52B) associated with respective performance metrics PM1, PM2 . . . PMn (column 52A). When the particular performance metrics PM1, PM2 . . . PMn are achieved by a player during game play, the associated modifications MOD1, MOD2 . . . MODn may be applied to the player's user profile.

The table 52 can also hold ranking information for the modifications, so as to allow a choice to be made between two or more modifications to be applied, as discussed later.

According to certain embodiments of the invention the modifications table may be held in the memory 28, 20 of a game system 2a, 2b, 2c. In these embodiments the invention is implemented on a stand-alone computer games terminal adapted for one or more players.

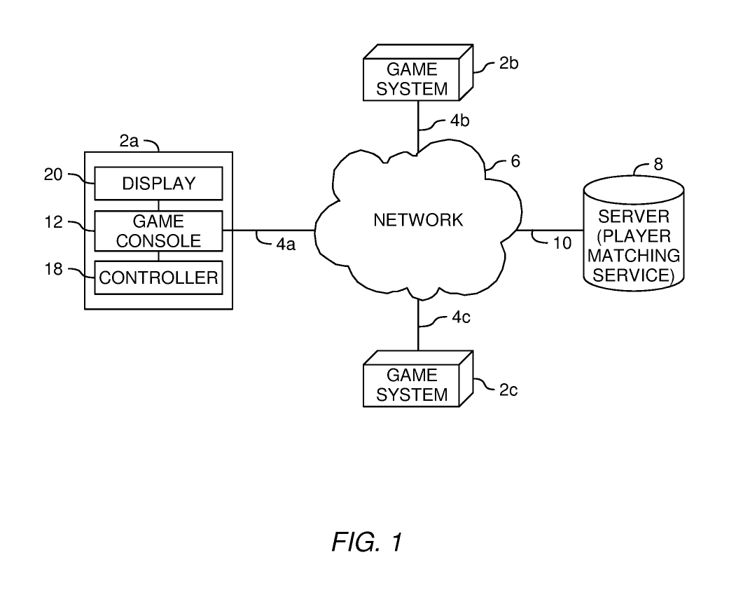

According to other embodiments of the invention the modifications table may be held at the memory 84 of the game server 8 as part of an online gaming session. In such embodiments the computer games terminal 2a, 2b, 2c forms part of a network as shown in FIG. 1, the network comprising a plurality of computer games terminals 2a, 2b, 2c and a server 8. The computer game may thereby be played online over the network by a plurality of players each at different computer games terminals 2a, 2b, 2c.

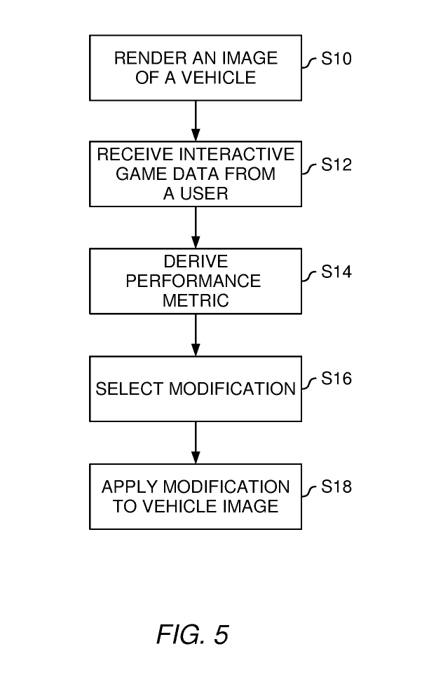

Referring to FIG. 5 there is shown the main process steps in operating the computer game. When a player begins a computer game an image of a graphical object (in this case the basic vehicle) is rendered S10. The image is displayed on the display 20 of the game system 2a, 2b, 2c by the graphics processor 24 and the graphics driver 22. Upon playing the game a user provides inputs to a controller 18. The controller 18 may be separate to the games console 12, or may be integrated therein. The user inputs are in the form of the actuation of the various buttons, levers and knobs of the controller 18. The controller converts the user inputs to interactive game data and transmits it to the console 12. The interactive game data is received S12 at the games console 12 by the controller interface 32. Performance metrics 52a are derived S14 from the received interactive game data by the central processor unit 26. That is, the performance metrics are derived from the overall performance of the graphical object, as it is manipulated by the interactive game data. In other words, how the user is performing (i.e. driving) requires consideration of the overall game context, not just the user inputs. As described herein, performance metrics encompass relationships within the game, such as passing other cards, colliding with objects, vehicle speed, etc., which cannot be determined just from the user inputs. One or more modifications 52b are selected S16 based on the one or more performance metrics 52a. The one or more selected modifications are selected from a table of modifications stored in memory and shown in FIG. 4. The one or more selected modifications 52b are applied S18 to the vehicle image by the central processor unit 26.

In embodiments of the invention where the modifications table is stored in the memory 28, 30 of the games console 12 the means for selecting the modification is provided by the central processor unit 26. In one embodiment this can be implemented by a modification manager 27 in FIG. 28 which is a program stored in the memory 28 for execution by the CPU 26 that is responsible for monitoring the user's gameplay, deriving the various performance metrics, and then selecting the appropriate modifications. In embodiments of the invention where the modifications table is stored in the memory 84 of the game server 8 the performance metric is transmitted over the network 6 by the network interface 42 of the games console 12. The network interface 80 of the game server 8 receives the performance metrics from the network 6. The means for selecting the modifications is provided by the modification selection means 82. The modification selection means 82 may be any combination of hardware and software (such as a CPU programmed with the modification manager described above). Modifications are selected based on the received performance metric and the selected modification is transmitted to the games console 12 over the network 6 by the network interface 80.

The application S18 of the modifications 52b to the vehicle image may be by way of storing the modification in the player's user profile 50. As the player progresses through the game and various modifications 50c, 50d are applied to their user profile 50 and the basic rendered image of the vehicle plus the modifications are displayed.

According to embodiments of the invention, a user cannot customize certain aspects of their own vehicle through personal selection. These aspects of the vehicle become customized on an automated basis by modifications made to the vehicle based on performance metrics derived from the user's game play.

For example, in certain embodiments a player may not be able to customize any aspects of their vehicle as all customization may be performed automatically as a result of game play. In other embodiments a player may be able to customize basic features of their vehicle such as the type of vehicle or the basic color of the vehicle, but may not be able to customize other features such as the bodywork or livery of the vehicle. The aspects of the vehicle which may not be customized by a player are modified or customized automatically as a result of game play.

It will be appreciated by those skilled in the art that the types and combinations of modifications that may or may not be performed by players are not limited to the examples given above. The invention encompasses any combination of allowable and unallowable modifications.

In an exemplary embodiment of the invention, MOD 1, denoted by numeral 50c, may be a modification to the basic vehicle, denoted by numeral 50b, which is controlled by a player. For example the basic vehicle may be any type of vehicle supported by the game e.g. a racing car and MOD1 50c may represent the color of the racing car, e.g. red, which is selected by the player. The player, in the exemplary embodiment, may therefore select a red racing car manually. MOD2 50d may be a modification to the vehicle 50b performed automatically based on player game play in accordance with the invention. Automatic modifications may be based on different features of game play and are discussed in detail below. There may be any number of modifications 50c, 50d to the basic vehicle 50b depending on memory space available.

It will be appreciated that although the user profile 50 is shown having fields containing individual modifications to a vehicle, it is also possible for the user profile to simply hold links or pointers to the modifications held in a modification table 52 shown in FIG. 4 and described below. Any suitable data structure can be utilized.

In certain embodiments of the invention the performance metrics 52a contained within the modifications table 52 may comprise particular milestones or sections of a game completed by a player. Performance metrics 52a may be attributed to one or more of the following milestones:
Completing a particular number of races;
Completing a particular set of races;
Scoring a particular number of points within a particular gaming session;
Achieving a particular ranking on a leaderboard; and
Attaining particular times on particular race courses.

It will be apparent to those skilled in the art that the invention is not limited to the attribution of performance metrics to the example milestones provided above. In accordance with the invention performance metrics may be similarly attributed to other milestones that represent a players achievements or progress in a game.

In computer racing games of the art the completion of races is displayed to a player. Progress through the game may be measured based on the completion of races.

In accordance with the invention the number of races completed by a player may be recorded using the player's user profile 50. The number of completed races may be stored in the memory units 28, 30 of a game system 2a, 2b, 2c associated with a particular player's user profile 50. A performance metric 52a may be stored in the modifications table 52 that is attributed to the completion of a particular number of races by a player. For example the performance metric 52a may be attributed to the completion of 100 races. The skilled worker will understand that the invention is not limited to a performance metric 52a attributed to the completion of 100 races but alternative performance metrics 52a may be attributed to the completion of other numbers of races.

Once a player has completed the particular number of races then the modification 52b associated with that performance metric 52a may be applied to a player's user profile 50.

In other embodiments of the invention a performance metric 52a may be attributed to the completion of a set of races. For example, a racing game may comprise a set of races all associated with a particular stage, environment or geographical area within the game play environment. In order to progress through a game a player may be required to complete all of the races within a particular stage, environment or geographical area. In accordance with the invention the completion of races may be monitored and stored. In particular, a game may monitor the completion of predetermined sets of races. The completion of such a set of races may result in the achievement of a performance metric 52a attributed to it. Therefore, a player may receive a modification 52b to their vehicle for the completion of such a set of races and the modification may be applied to their user profile 50.

Computer racing games of the art award points to players based on their performance within a gaming session. In accordance with the invention the number of points awarded to a player for a gaming session may be stored in memory units 28, 30 of game system 2a, 2b, 2c. A performance metric 52a may be attributed to a player amassing a particular number of points within a gaming session. For example, if a player achieves more than a particular number of points, say 10,000 points, in a particular race, they may meet the criteria for a related performance metric 52a. In that instance the modification associated with the particular number of points may be applied to a player's user profile 50.

It is known in computer racing games to generate leaderboards comprising the highest performing players of the game. The leaderboards may be generated based on any chosen criteria, such as the fastest or the highest scoring players. The leaderboards of the art may be stored in the memory units 28, 30 of a game system 2a, 2b, 2c. Alternatively the leaderboards may be stored in the game server 8 and may be displayed to players of an online computer gaming session via the network 6 and the display 20 of a game system 2a, 2b, 2c.

According to the invention a performance metric 52a may be based on a player's ranking in a leaderboard. For example if a player is first, second or third in a leaderboard then they may achieve the related performance metric 52a. The associated modification 52b may then be applied to the player's user profile 50.

In known computer racing games the times taken for a player to complete gaming sessions are displayed via display 20 of game system 2a, 2b, 2c. The times may represent the time taken to complete races, laps of races or sections of laps of races.

In accordance with embodiments of the invention the times taken for a player to complete a gaming session may be stored in the memory units 28, 30 of a game system 2a, 2b, 2c. In particular, the fastest times taken for a player to complete a gaming session may be stored. If a time stored and associated with a user profile 50 is quicker than a particular time set as a performance metric 52a then a player may be awarded the associated modification 52b. The modification may then be applied to the user profile 50 of the player.

In certain embodiments of the invention the performance metrics 52a contained within the modifications table 52 may comprise data relating to the game play of a player. For example a player may exhibit a particular style when driving their vehicle around the courses of the game. The driving style of a player may for instance include one or more of the following qualities:
Drifting/sliding around corners of a course;
Jumping; and
Slipstreaming a rival player.

Performance metrics may be attributed to any of the above mentioned driving styles or to any combination thereof; however the skilled worker will appreciate that the invention is not limited to the driving styles listed above. Any other driving styles or a combination thereof are also within the scope of the invention.

As mentioned herein “drift” is the amount of sideways motion of a vehicle when negotiating the corners of a course within the game play environment.

In accordance with the invention the amount of drift of a vehicle may be measured by a computer racing game using a ratio of forward motion of the vehicle to sideways motion of a vehicle. The game may also measure the amount of time a car spends drifting over the course of a gaming session by noting and recording the processor time when the vehicle began to drift and noting and recording the processor time when the vehicle ceased to drift. The summation of all the times when the vehicle drifted during a gaming session would provide the total drifting time during a session. These measurements may be stored in the memory units 28, 30 of a game system 2a, 2b, 2c and associated with the user profile 50 of the player playing the game when the measurements were taken.

The same timing mechanism may be applied mutatis mutandis to other performance metrics described herein.

A performance metric 52a may be attributed to a driving style including a large amount of drift. A performance metric may specify that a player should drift for a particular amount of time in particular gaming sessions to be awarded the associated modification 52b. For example if on a particular track a player is measured as drifting their vehicle for a particular amount of time then they may be awarded the modification 52b associated with that performance metric 52a. A performance metric may also be attributed to a percentage of a player's total time in a gaming session spent drifting their vehicle. If the percentage is above a threshold figure for the performance metric 52a then metric is achieved. Alternatively, the performance metric may be attributed to the measured severity of drift of a player during a gaming session. This may be measured based on the ratio of forward and sideways motion described above.

In accordance with the invention a computer racing game may also monitor and store the amount of time that a player spends jumping during a gaming session. If the amount of time spent jumping is greater than a threshold figure for a performance metric 52a then the associated modification 52b may be applied to a player's user profile. Alternative performance metrics 52a may be attributed to the length and/or height of a player's jumps. If the measured length and/or height of the player's jumps are greater than a threshold value for the performance metric 52a then the performance metric is achieved and the associated modification 52b applied to the user profile 50.

Also in accordance with the invention a computer racing game may monitor and record the amount of time a player spends during a gaming session slipstreaming rival players. By comparing the time spent slipstreaming with the total time of a gaming session a percentage of time that a player spends slipstreaming may be determined. If a particular percentage, which relates to a performance metric 52a, of a gaming session is spent slipstreaming then a player will achieve the performance metric 52a and be awarded the associated modification accordingly. In other embodiments the number of overtaking maneuvers that a player is able to complete as a result of slipstreaming during a gaming session may be monitored and recorded. If the number of maneuvers is greater than a threshold value attributed to a performance metric 52a then the player may be awarded the associated modification 52b.

As used herein “slipstreaming” encompasses the act of a player placing their vehicle closely behind a rival's vehicle in order to reduce drag on the player's vehicle. The act of slipstreaming allows extra speed to be generated and increases the likelihood of overtaking the rival vehicle whose slipstream has been utilized.

Additional performance metrics which are monitored in game play to select modifications for customizing the vehicle may include: the position of the player in a particular race, extracted for example from an online leader board; success with certain challenges in a game, progress through different levels of the game; and achievements within a game (which can be individual achievements or achievements relative to other players of the game) etc.

The above descriptions of the mechanisms for determining performance metrics 52a and for associating them with particular modifications 52b are illustrative only. The skilled worker will appreciate that there are many other methods that may be used to monitor and record a particular performance metric. The invention is therefore not limited to the mechanisms described above but rather is directed to the concept of monitoring and recording a player's performance using a series of applicable metrics and automatically awarding a player a modification to their vehicle based on that performance.

In accordance with the invention the rendered image of a player's vehicle displayed to other players within the game play environment will display the basic vehicle 50b plus any modifications 50c, 50d that have been applied to the player's user profile 50. The modifications may be user controlled or automatically applied as described above. Further progress through the game may result in further modifications to a player's car.

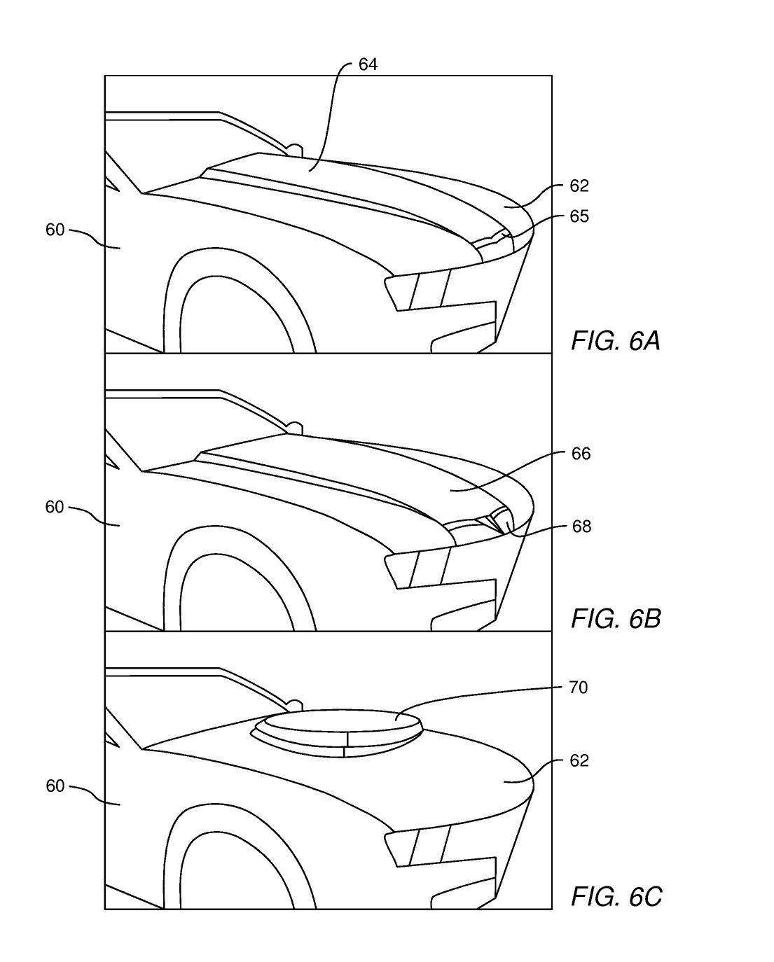

FIGS. 6A to 6C show modifications to a player's vehicle that are mutually exclusive. For example, the modification of FIG. 6B may not be applied to a player's vehicle simultaneously with the modification of FIG. 6A. In such circumstances, and according to the invention, a game may select a modification to be applied to the rendered image. The game may select the modification which best displays a player's ability, skill level and/or progress through the game. Alternatively, a game may select the highest ranked modification.

Information regarding the modifications made to players' vehicles may be available to other players within the game play environment. For instance a list of modifications 52b and their associated performance metric 52a may be held in the memory units 28, 30 of a game system 2a, 2b, 2c. On selection of the relevant icon or tab within the game play environment the information relating to modifications may be displayed to players via display 20. For example, the information may state that a player who has one longitudinal stripe across the middle of their vehicle has completed at least 100 races, a player with two such stripes has completed 250 races and so on. In this way players may be aware of a player's driving style, achievements and progress through the game from the rendered image of that player's vehicle.

In embodiments of the invention, as a game is played, the CPU 26 has a computer program which automatically makes decisions based on a player's progress and style of play and which modifies the vehicle to create a customized vehicle personalized to uniquely represent the player. The customizations can include a number of different elements, comprising body kit, logos, badges and livery. There is no requirement for a user interface to customize a vehicle—vehicle customization may be completely automated.

Embodiments of the invention provide a method of customizing a vehicle which does not require any input from a player. This has significant advantages over the vehicle modification methods known in the art, which rely on players manually modifying or customizing their vehicles using mechanisms that are cumbersome and unwieldy. The automated nature of the vehicle modifications of the invention ensure greater customization and personalization of player vehicles within the game and also promote increased game play as players may covet particular modifications that represent certain skills or the completion of particular stages of a game and spend time playing a game to achieve them.

The invention may cover modifications to vehicles in the following areas:
Its physical shape;
Its color and decorative features such as paint, liveries and decals; and
Its performance characteristics and capabilities.

As used herein the term “decals” encompasses stickers, badges, emblems or other insignia that may be displayed on a rendered image of the vehicle. In accordance with the invention each decal may be placed on a player's vehicle in recognition of the player's own achievements during their experience of the game. This means that when comparing each other's vehicles, two players will see many differences. The differences will be indicative of the different experiences of each player within the game play environment.

In accordance with the invention a vehicle's physical shape may be modified as a result of the completion of a particular performance metric. It has been found to be best to focus on individual details on a vehicle. FIGS. 6A to 6C show an exemplary set of physical shape modifications that may be applied to a player's vehicle. Specifically, FIGS. 6A to 6C show possible modifications to the bonnet of a player's vehicle. It will be appreciated that the invention is not limited to the examples shown but may cover any type of modification to the physical shape of a vehicle.

In FIG. 6A a player's vehicle 60 has been modified by the addition to the hood 62 of a raised central portion 64 running longitudinally along the bonnet toward an air intake 65 at the front of the vehicle. In FIG. 6B a separate raised portion 66 has been added to the bonnet. The raised portion 66 is wider and comprises a more intricate air intake 68 when compared to the raised portion 64 and the air intake 65 of FIG. 6A. In FIG. 6C the player's vehicle 60 has been modified through the addition of a highly pronounced air intake 70 placed on the hood 60 above the engine.

In certain embodiments of the game the modifications shown in FIGS. 6A to 6C may signify a player's progress through the game. Each modification may signify the completion of a particular section of a game. The addition of the modifications of FIGS. 6A to 6C may be linear or non-linear.

In addition to the modifications to the hood of a vehicle shown in FIGS. 6A to 6C the invention encompasses other physical shape modifications.

The invention may apply modifications to the rear spoiler of a vehicle. A basic vehicle shape may comprise no rear spoiler at all. Modifications applied to the basic vehicle shape in accordance with the invention may introduce a rear spoiler. Different modifications may apply different spoiler designs having different supporting struts and differently shaped airfoil surfaces. In addition to modifying the appearance of a vehicle, the rear spoiler may also affect the performance characteristics and capabilities of a vehicle.

The invention may apply modifications to the wheels of a vehicle. For example the number of spokes of a wheel, whether they are steel or alloy, and their general design may all be modified.

The invention may also apply modifications to the exhaust of a vehicle. The position, number and design of the exhaust may be altered.

Combinations of the modifications (plus many others) may provide a player's vehicle with a physical shape unique to them. According to the invention this is as an automatic by-product of a player playing a game.

Beyond the physical shape of the vehicle, its decoration may be influenced by the player's performance and achievements in the same way. This may take one or more the following forms:
Colour
Liveries
Materials
Lights
Decals
Race Number

The materials of a vehicle encompass the structural materials of the vehicle, such as fibre glass bodywork or alloy wheels, and the decorative or appearance related materials, such as metallic paint or glittered decals.

The lights of a vehicle may also be modified in accordance with the invention. The number, position and style of front and rear lights may, for example, be modified.

Brand logos such as “Champion®”, “DeWalt®” and so on are placeholder examples of decals that may be featured in a computer racing game. In accordance with the invention, in order for a player to have the “Champion®” decal placed on their vehicle automatically, they would need to achieve a particular performance metric within the game play environment. As players achieve a variety of performance metrics, so their vehicles become decorated with a variety of decals.

The modifications described above refer to the appearance of the vehicle in a vehicle image which is rendered in game play by the CPU 26 on the display 20.

In addition to aesthetic modifications made to a player's vehicle, a number of changes may also be made that affect performance. That is, the modifications to the vehicle can include performance elements of the vehicle which affect how the rendered image of the vehicle behaves in the game responsive to actuation of control elements on the input device. Thus, the vehicle can, for example, be modified to simulate e.g. the effect of an upgraded chassis or more powerful engine by the responses of the vehicle in game play. Vehicle performance can be improved or bolstered with the addition of new abilities as the player makes progress through the game. Once again, these modifications may be automated, driven by the analysis of player data in order to evolve the vehicle to suit a player's style. The enhancements include:
Improvements in control, making a vehicle feel different to use. This could be in the form of making a vehicle faster, stronger, more nimble, anything that enhances the experience of using that vehicle through a controller 18;
The addition of new abilities and capabilities that have previously been unavailable, such as the addition of a weapon or the ability to fly.

Additional abilities may require additional control input from the player in order to utilise them. This may open up new areas of game play experiences that were simply not possible with the same vehicle in its previous guise.

In one embodiment, modifications used to customize the vehicle are appropriate to the underlying performance metric, where different performance metrics accrue different modifications. For example, a two digit racing number can be applied to the vehicle derived from an online leader board position. Badges or logos can be applied to the vehicle based on particular achievements within a game. The livery of a vehicle can become increasingly complex as a player moves through different levels of a game. The bodywork and performance of the vehicle can be changed based on the driving style of a player.

Thus, the customization of the vehicle is a non-linear customization in the sense that each individual performance metric gives rise to a different modification and is not dependent on having achieved earlier modifications of a vehicle.

Although described with reference to a race game in which the rendered graphical objects are vehicles, the invention is applicable to other scenarios where the graphical object can be an avatar or any other object.

The modifications need not change the visual appearance of the image itself. Feedback to a user could also be by way of audio signals or changes associated with the image, such as vibration or emission of exhaust fumes. Alternatively or additionally, there could be force feedback to a user through the controller.

An embodiment of the invention may include a video game device capable of executing a video game program that incorporates the applications in arrangements discussed herein.

While such an interactive game program can be executed under any computer system capable of communicating with other devices, the following description is directed to an interactive game program being executed by an interactive game device (e.g., a particular example of an information processing device or computing device) which may be a standalone device for one or more users or a device capable of communicating with other devices.

The invention is not limited to use with a particular interactive game device, but may be implemented with any interactive game device capable of executing an interactive game program according to the present invention. The invention may, for instance, be implemented on devices such as a portable interactive game device, an interactive game device adapted for use with a television or other monitor, a computer such as a desktop, laptop, notebook, or other computer, a telephone such as a cellular phone, or any other electronic device adapted for running an interactive game program including the animation methods of the invention.

What is claimed is:

1. A method of operating an interactive computer game comprising:
receiving interactive game data from a user for playing a game, said game data controlling animation of an image of a graphical object rendered on a display of a computer games terminal;
deriving at least one performance metric based at least in part on the interactive game data;
selecting at least one modification from a set of predetermined modifications associated with the at least one performance metric; and
automatically applying the at least one modification to the graphical object, without requiring input data from the user to select said modifications.

2. The method of claim 1, wherein the graphical object is a vehicle.

3. The method of claim 1, wherein the graphical object is an avatar.

4. The method of claim 1, wherein said at least one modification affects the appearance of the image and is selected from the group comprising: color; liveries; materials; lights; decals; race number; and physical shape.

5. The method of claim 2, wherein said at least one performance metric is related to the position of a participant vehicle in a multi-user game, the race number being selected based on said position.

6. The method of claim 1, wherein said at least one modification affects the performance characteristics and capabilities of the animation of the graphical object in the game responsive to game data received from the user, such that the object exhibits a performance altered by the modifications.

7. The method as claimed in claim 1, wherein the modification provides feedback to a user as one or more of (a) visual change of the image; (b) an audio signal; and (c) force feedback to a game controller operated by the user.

8. The method of claim 6, wherein said at least one modification is selected from the group comprising: improvements in control; and the addition of new abilities.

9. The method of claim 1, wherein said at least one performance metric is based on a player's progress through the interactive game and is selected from the group comprising: completing a predetermined number of races; completing a predetermined set of races; scoring a predetermined number of points within a gaming session; achieving a predetermined ranking on a leaderboard; and attaining a predetermined time on a race course.

10. The method of claim 1, wherein said at least one performance metric is derived based on a player's style of game play and is selected from the group comprising: drifting around the corners of a course; jumping; and slipstreaming a rival player.

11. The method of claim 1, comprising storing said set of predetermined modifications in a first storage means; and
maintaining a user profile in a second storage means, wherein said applying includes adding said selected at least one modification to the user profile at said second storage means.

12. The method of claim 11, wherein the interactive computer game is operated in a network comprising a server and a plurality of computer game terminals and wherein the first storage means is located at a server and the second storage means is located at the computer games terminal.

13. A system for operating an interactive game comprising:
means for receiving interactive game data from a user for playing a game, said game data controlling animation of an image of a graphical object rendered on a display of a computer games terminal;
means for deriving at least one performance metric based at least in part on the interactive game data;
means for selecting at least one modification from a set of predetermined modifications associated with the at least one performance metric; and
means for applying the at least one modification to the graphical object without receiving data from the user to select said at least one modification.

14. The system of claim 13, comprising means for rendering an image of a vehicle on a display of the computer games terminal.

15. The system of claim 13, further comprising a first storage means for storing the set of predetermined modifications and a second storage means for maintaining a user profile, wherein the means for applying the at least one modification to the graphical object is adapted to add the selected at least one modification to the user profile at the second storage means.

16. The system of claim 15, wherein the computer game is operated in a network comprising a server and a plurality of computer game terminals and wherein the first storage means is located at a server and the second storage means is located at the computer games terminal.

17. The system of claim 15, wherein the computer game is operated on a computer games terminal, and wherein the first and second storage means are located at the computer games terminal.

18. A game server for managing an interactive computer gaming session connected in a network to a plurality of computer game terminals comprising:
a network interface adapted to receive over the network from a computer games terminal one or more performance metrics based on interactive game data received from a user at the computer games terminal; and
a modification selecting component arranged to select at least one modification from a set of predetermined modifications stored in a memory, based at least in part on the one or more performance metrics without requiring user input data,
wherein the network interface is also adapted to transmit the selected at least one modification over the network to the computer games terminal.

19. A computer games terminal for operating an interactive computer game comprising:
a processor; and
a memory storing program code which when executed causes the processor to:
render an image of a graphical object on a display of the computer games terminal;
receive interactive game data based on user inputs, the game data controlling animation of the image in the game;
determine at least one performance metric based on the interactive game data; and
apply at least one modification, selected from a set of predetermined modifications, to the graphical object without requiring input data from the user to select said at least one modification.

20. The computer games terminal as claimed in claim 19, wherein the object is a vehicle.

21. A computer readable storage medium containing a program which, when executed performs an operation for operating an interactive computer game on a computer games terminal, the operation comprising:
rendering an image of a graphical object on a display of the computer games terminal;
receiving interactive game data from a user for playing a game, said interactive game data controlling animation of the image in the game;
deriving at least one performance metric based at least in part on the interactive game data; and
applying at least one modification, selected from a predetermined set of modifications, to the graphical object, without requiring input data from the user to select said modifications.

22. The computer readable storage medium of claim 21, wherein the object is a vehicle.

23. The computer readable storage medium of claim 21, wherein said at least one modification affects the appearance of the image and is selected from the group comprising: color; liveries; materials; lights; decals; race number; and physical shape.

24. The computer readable storage medium of claim 21, wherein said at least one performance metric is related to the position of a participant vehicle in a multi-user game, the race number being selected based on said position.

25. The computer readable storage medium of claim 21, wherein said at least one modification affects the performance characteristics and capabilities of the animation of the graphical object in the game responsive to game data received from the user, such that the object exhibits a performance altered by the modifications.

26. The computer readable storage medium of claim 21, wherein said at least one performance metric is based on a player's progress through the interactive game and is selected from the group comprising: completing a predetermined number of races; completing a predetermined set of races; scoring a predetermined number of points within a gaming session; achieving a predetermined ranking on a leaderboard; and attaining a predetermined time on a race course.

27. The computer readable storage medium of claim 21, wherein said at least one performance metric is derived based on a player's style of game play and is selected from the group comprising: drifting around the corners of a course; jumping; and slipstreaming a rival player.

28. A computer readable storage medium containing a program which, when executed performs an operation for operating a server in a network comprising a plurality of computer games terminals connected to each other and to the server, the operation comprising:
receiving over the network from a computer games terminal one or more performance metrics based on interactive game data received from a user at the computer games terminal;
selecting at least one modification from a set of predetermined modifications stored in a memory based at least in part on the one or more performance metrics without requiring user input data; and
transmitting the selected at least one modification over the network to the computer games terminal.
